(19) United States
(12) Patent Application Publication
(10) Pub. No.: US 2026/0024930 A1
(43) Pub. Date: Jan. 22, 2026

(54) PLUG CONNECTOR AND SET HAVING A PLUG CONNECTOR AND A SOLDER ANCHOR

(71) Applicant: WAGO Verwaltungsgesellschaft mbH, Minden (DE)

(72) Inventor: Rudolf MASTEL, Minden (DE)

(73) Assignee: WAGO Verwaltungsgesellschaft mbH, Minden (DE)

(21) Appl. No.: 19/273,055

(22) Filed: Jul. 17, 2025

(30) Foreign Application Priority Data
Jul. 19, 2024 (DE) 20 2024 104 040.6

(51) Int. Cl. H01R 12/70

(52) U.S. Cl. CPC H01R 12/707

(57) ABSTRACT

A plug connector for connection to a printed circuit board is described wherein the plug connector has a connector housing and electrical contacts for contacting mating contacts of a mating connector that is connectable to the plug connector. In addition, the plug connector has a separately formed solder anchor arranged on the connector housing for mechanically securing the connection of the plug connector to the printed circuit board.

This nonprovisional application claims priority under 35 U.S.C. § 119 (a) to German Patent Application No. 20 2024 104 040.6, which was filed in Germany on Jul. 19, 2024, and which is herein incorporated by reference.

### BACKGROUND OF THE INVENTION

### Field of the Invention

The invention relates to a plug connector for connection to a printed circuit board, wherein the plug connector has a connector housing and electrical contacts for contacting mating contacts of a mating connector that is connectable to the plug connector, and wherein the plug connector has a separately formed solder anchor arranged on the connector housing for mechanically securing the connection of the plug connector to the printed circuit board.

### Description of the Background Art

Plug connectors for connection to a printed circuit board are known in the field of electrical wiring. Such plug connectors are arranged on the printed circuit board and are connected both mechanically and electrically thereto. They can have corresponding solderable connection surfaces as contact regions for electrical joining to the printed circuit board. In order to secure the mechanical connection between the plug connector and the printed circuit board against unintentional separation, for example on account of tensile forces acting on the plug connector, it is known to additionally fasten the plug connector to the printed circuit board by means of a so-called solder anchor or solder-in anchor in that the solder anchor is attached to a connector housing of the plug connector and is integrally connected to the printed circuit board. Such solder anchors must be relatively robust in design in order to be able to ensure adequate mechanical securing, and therefore often occupy considerable additional installation space on the plug connector. Moreover, the voltage characteristics of the solder anchor with regard to required clearances and creepage distances must be taken into account, which can likewise affect the design layout and dimensioning of the plug connector.

### SUMMARY OF THE INVENTION

It is therefore an object of the present invention to provide an improved plug connector having a solder anchor that is connected to the plug connector with a reduced installation space requirement and nevertheless ensures reliable mechanical securing.

The object is attained by a plug connector as well as by a set having a plug connector and a solder.

For a generic plug connector for connection to a printed circuit board that has a connector housing and electrical contacts for contacting mating contacts of a mating connector that is connectable to the plug connector and has a solder anchor that is formed, which is to say shaped, separately from the connector housing and the electrical contacts, wherein the solder anchor is arranged on the connector housing and is designed for mechanically securing the connection of the plug connector to the printed circuit board, it is proposed that the solder anchor is designed as an essentially flat, planar component and has, on a first anchor side, a soldering section for connection to the printed circuit board, and has, on a second anchor side opposite the first anchor side, a bent locking section for interlocking engagement in a locking opening of the connector housing, wherein the soldering section and the locking section are connected to one another by a connecting section, and wherein an attachment section, which is accommodated in an interlocking manner in a solder anchor receptacle of the connector housing, projects from the connecting section.

In simplified terms, a plug connector is proposed having a solder anchor that can be arranged in an especially space-saving manner on the plug connector owing to a two-dimensional design and that does not appreciably increase the size of the plug connector in the region of the solder anchor, in particular in a pitch direction of the plug connector, which can correspond to a direction of a lining-up of the electrical contacts of the plug connector. The low-profile character of the proposed anchor solution is further enhanced by the recessing of the solder anchor that is achievable, at least in the attachment section, in a solder anchor receptacle set into the connector housing. At the same time, the solder anchor is mechanically secured to the connector housing in multiple ways by the attachment section and the locking section so that a robust and strong use of the solder anchor is made possible despite the compact design. In particular, the solder anchor can be secured to the connector housing by different directions of interlock in the attachment and locking sections for improved strength when forces act in different directions, as will be explained in greater detail below. As a result, a plug connector with a solder anchor that is advantageously small in size but nevertheless strong can be made available.

“Separate” can be understood as a solder anchor that is produced separately (apart) from other components of the plug connector and is handled as a single part in production and installation, and that is mounted as a single part on the plug connector. Owing to its solely interlocking connection to the plug connector, in particular the connector housing, the separate solder anchor remains detachable therefrom. The solder anchor is not integrally connected to other parts of the plug connector.

The solder anchor can be designed as an essentially flat, planar component. A “planar component” can be understood as a two-dimensional component with substantially greater length and width extents than its depth extent. The planar component can be implemented as a sheet-metal component, for example, in particular be stamped from a semifinished sheet metal product, for example. “An essentially flat, planar component” describes, in particular, a planar component that has a predominantly level surface. For example, a proportion of at least 70%, at least 80%, or at least 90% of a contiguous surface side of the planar component can extend in a common plane. The solder anchor can have a shape that is straight or flat, not curved, with the exception of the locking section, in particular.

The solder anchor can have a first anchor side and a second anchor side, wherein the second anchor side lies opposite the first anchor side. In other words, the first and second anchor sides can designate two opposite end sections of the solder anchor. The first anchor side can face toward a circuit board side—intended for arrangement on a printed circuit board—of the connector housing, while the second anchor side can face away from the circuit board side and, for example, project toward a housing top of the connector housing opposite the circuit board side.

The soldering section of the solder anchor can be a region of the solder anchor that is intended for integral attachment to the printed circuit board. The soldering section can be formed as, e.g., a solder pin, which is to say have an elongated, straight extent. The locking section can be designed as a material tab with a rectangular basic shape, for example. The locking section can have a width that is substantially identical to the soldering section, wherein a width direction of the solder anchor can be defined perpendicular to a main direction of extent of the solder anchor along its largest dimension. The locking section can have a shorter length than the soldering section, wherein a length direction of the solder anchor can be defined along a main direction of extent of the solder anchor in accordance with its largest dimension.

The locking section can be bent for an interlocking engagement in a locking opening of the connector housing. This feature can be present, in particular, in a final assembled state of the solder anchor on the plug connector. In an intermediate assembly state, the solder anchor can be arranged on the plug connector as a flat, planar component with no bend, and be transformable into the final assembled state by bending the locking section into the locking opening. Owing to the design of the solder anchor as a planar component, such a bending procedure is possible without applying excessive force. The locking opening can be, for example, an indentation in the connector housing opposite the locking section that is framed by housing edges bordering the locking opening. The bent locking section can insert into the locking opening and form an undercut with at least two adjacent housing edges so that a directional interlock can be produced. Owing to the engagement of the bent locking section in the locking opening, reliable support of the solder anchor on the connector housing can be ensured, in particular when tensile forces are introduced into the plug connector. For example, in the event of a tensile force opposite a mating direction of the plug connector or at a right angle opposite to the printed circuit board, the tensile force can lead to an opposed rotation of the connector housing and of the solder anchor, which is suppressed by the engagement of the locking section in the locking opening and is carried away as a total force into the soldering section of the solder anchor connected to the printed circuit board. In particular, a bracing between the solder anchor and the connector housing can be achieved by means of the separate fastening points of the solder anchor in the attachment section and in the locking section.

The soldering section and the locking section can be connected to one another by a connecting section. The connecting section can extend between the soldering section and the locking section with a straight shape so that the soldering section and the locking section extend essentially along a common straight line without lateral offset from one another. The connecting section can have a greater length than the locking section. The connecting section can be at least as long as the soldering section, for example.

An attachment section can project from the connecting section. This attachment section projects in a width direction of the solder anchor, in particular laterally. The attachment section can have a larger width dimension than the locking section and the soldering section. The attachment section can have a larger length dimension than the locking section. The attachment section can have a smaller length dimension than the soldering section. The attachment section can have an attachment element, for example an interlocking contour and/or a latching element, for fastening the solder anchor to the connector housing.

When a tensile force substantially perpendicular to the printed circuit board occurs, a torque acts on the connector housing as a result, and this is transmitted to the connector housing. In this case, two different opposing torques act on the solder anchor. A force acts on the locking section in the mating direction, and a force directed away from the printed circuit board acts on the attachment section. These two forces cause opposing torques on the solder anchor, which largely compensate for one another so that the solder anchor is not twisted, but merely loaded with a tensile force. This is advantageous for the solder joint as well as for the entire arrangement (no rotation of the connector housing).

The attachment section can be accommodated in an interlocking manner in a solder anchor receptacle of the connector housing. The solder anchor receptacle can be, in particular, a material recess with an interlocking contour in the connector housing, in which the solder anchor can be arranged in an interlocking manner. In particular, the solder anchor can form an undercut with the interlocking contour of the solder anchor receptacle on at least two sides so that a directional interlock can be produced. The solder anchor receptacle can be formed on a housing external surface of the connector housing. The solder anchor receptacle can be formed on an end face of the connector housing, wherein the end face can run essentially perpendicular to a contact side of the plug connector for contact with a mating connector and perpendicular to a circuit board side of the connector housing.

A first direction of interlock between the attachment section and the solder anchor receptacle can run essentially perpendicular to a second direction of interlock between the locking section and the locking opening. As a result, an interlocking retention of the solder anchor on the connector housing can be provided in multiple spatial directions so that the solder anchor is fixed securely and strongly on the connector housing even when forces act from different directions. The particular direction of interlock can be defined by the direction of a normal force acting between an interlocking contour of the solder anchor and a corresponding mating contour of the connector housing. The direction of interlock between the attachment section and the solder anchor receptacle can run parallel to a direction of extent of the connector housing between the circuit board side and a housing top of the connector housing opposite the circuit board side, for example. The direction of interlock between the locking section and the locking opening can run parallel to a mating direction of the plug connector for connecting the plug connector to a mating connector, for example. An especially secure retention of the solder anchor on the connector housing is ensured by directions of interlock of different sections of the solder anchor that are orthogonal to one another.

An exposed contact surface can be formed on a surface of the solder anchor facing away from the connector housing. In other words, the solder anchor can be arranged on the connector housing largely uncovered by the connector housing. For example, at least 80% or at least 90% of a surface of the solder anchor facing away from the connector housing can be arranged to be exposed. For example, the solder anchor can be partially surrounded by the connector housing solely in regions of an interlocking undercut with the connector housing. The exposed contact surface can be configured for a contact with a shield element that can be arranged on the connector housing while contacting the exposed contact surface of the solder anchor.

The solder anchor receptacle of the connector housing can have an insertion opening for sliding the solder anchor into the solder anchor receptacle along a housing surface of the connector housing in a predefined insertion direction. As a result, the attachment of the solder anchor to the connector housing can be accomplished in a simple manner, wherein the design of the solder anchor as a planar component advantageously can be used for guiding the solder anchor along the housing surface. The insertion opening can be formed between the housing webs for guiding the attachment section, for example. The insertion direction can run parallel to a mating direction of the plug connector for connection to a mating connector.

The insertion direction of the solder anchor in the solder anchor receptacle can be in the opposite direction to a mating direction of the plug connector for connection to a mating connector. By this means, an unintentional detachment of the solder anchor through mechanical contact with a component of the mating connector and a potentially associated pushing of the solder anchor out of the solder anchor receptacle during a mating process is avoided.

A latching element that can be configured to latch onto a mating latching element of the solder anchor receptacle and/or to dig into the material of the connector housing inside the solder anchor receptacle with a sharp-edged region can be arranged on the attachment section of the solder anchor. As a result, a reliable and secure fixing of the solder anchor to the connector housing is possible. According to one design possibility, the attachment section can have two latching elements that can latch with correspondingly arranged mating latching elements of the solder anchor receptacle so that uniform and secure latching is achieved. The latching element of the solder anchor can be a locking hook, for example, and the mating latching element of the solder anchor receptacle can, for example, be a latching projection with a latching edge that the locking hook can engage behind. The attachment section can have a latching section on which the latching element is arranged. The latching section of the attachment section can be formed on an end section of the attachment section that faces away from the connecting section. The solder anchor can be insertable or be inserted into the solder anchor receptacle with the latching section foremost.

The solder anchor receptacle of the connector housing can have two parallel housing webs reaching over the solder anchor for guiding the attachment section of the solder anchor in the solder anchor receptacle. As a result, the solder anchor can be transportable into an attachment position on the connector housing in a secure and defined manner. The housing webs can have a geometric guide profile, for example a stepped profile or an angled profile to form a dovetail contour, so that reliable interlocking guidance of the attachment section in the solder anchor receptacle is achieved. According to one design possibility, the above-described mating latching elements can be molded on the housing webs and project therefrom so that an attachment section of the solder anchor provided with latching elements can be guided along the housing webs into a latching position in which the latching elements can latch with the mating latching elements.

A support tab that can project from the connecting section for the purpose of supporting the solder anchor on a housing edge of the connector housing can be formed on the connecting section of the solder anchor. With the support tab, an additional force absorption on the solder anchor is possible and the latter is additionally stabilized on the connector housing. Furthermore, the solder anchor can be secured by the support tab against displacement toward a housing top of the connector housing opposite the circuit board side. With a suitable design, moreover, a bracing of the solder anchor between the support tab supported on the housing edge and the locking section supported on a housing edge bordering the locking opening can be achieved. The support tab can project from the connecting section at right angles thereto. In particular, two support tabs can project at opposite sides from the connecting section so that a cross-shaped support region is formed.

The solder anchor accommodated in the solder anchor receptacle can, at least in sections, terminate flush with the housing wall of the connector housing adjacent to the solder anchor receptacle. In particular, the solder anchor with the attachment section inserted in the solder anchor receptacle can terminate flush with the housing edges adjoining the solder anchor receptacle. This is made possible, in particular, by the design of the solder anchor as an essentially flat, planar component. Owing to the flush termination that is present at least in sections, additional accessory elements can be arranged on the housing side of the plug connector that is provided with the solder anchor, for example a locking latch for locking the plug connector to a mating connector connected to the plug connector. Furthermore, the installation space requirement of the solder anchor on the plug connector in its pitch direction is minimized.

The connector housing can have two solder anchor receptacles that are formed on two mutually opposite outer surfaces of the connector housing. An arrangement of the solder anchor on a choice of one or the other outer surface of the connector housing is made possible by this means. Furthermore, it is also possible to secure the connector housing by two solder anchors on the printed circuit board, each placed on an outer surface. As a result of the fact that the solder anchor is designed as a planar component that is separate and is flat in an intermediate assembly state, the locking section of the solder anchor can be bent in the respective direction of the locking opening of the connector housing after installation of the solder anchor on the connector housing in order to be converted into the final assembled state. Accordingly, a uniformity of components for solder anchors can be realized for the two outer surfaces of the connector housing. The mutually opposite outer surfaces of the connector housing can constitute end faces of the connector housing, wherein the end faces can run essentially perpendicular to a contact side of the plug connector for contact with a mating connector and perpendicular to a circuit board side of the connector housing.

The solder anchor can be produced as a stamped part. Simple and economical provision of the solder anchor is possible as a result. A stamped part can be viewed as a flat, sheet-metal part with a complex outer contour that is produced by cutting a semifinished, sheet-metal product. With a stamped part, an essentially flat, planar component can be provided that can be bent without applying excessive force, for example for bending the locking section of the solder anchor.

The plug connector can be designed as a contact pin strip or as a socket strip. Such plug connectors can be secured to a printed circuit board by a solder anchor, although they are likewise subjected in practice to occasional forces from different directions that require a reliable and strong mechanical connection, so that a solder anchor according to the above-described features can advantageously be employed for the aforesaid plug connector types. In addition, it can be desirable for contact pin strips or socket strips to provide them with an adjacent shield element and/or a locking latch, which advantageously can be realized by an exposed contact surface and a flush termination of the solder anchor, for example. A contact pin strip can be a plug connector with at least two electrical contact pins arranged side-by-side in a pitch direction of the plug connector. A socket strip can be a plug connector with at least two electrical contact pin receptacles arranged side-by-side in a pitch direction of the plug connector.

The invention also relates to a set having a plug connector and a solder anchor for creating a plug connector according to one of the above-described features. The above-described advantages of the plug connector can also be achieved with such a set, wherein the solder anchor as an accessory part can be arranged optionally on the plug connector, in particular optionally on different outer surfaces of the connector housing. In the set, the solder anchor can be implemented as a flat, planar component and be attachable to the plug connecter by sliding into the solder anchor receptacle so as to subsequently be secured mechanically to the connector housing by bending the locking section into the locking opening of the connector housing. According to one design possibility, the set can have the plug connector and at least two identically designed solder anchors. Moreover, a mating connector matching the plug connector can be a further component of the set so that a plug connector arrangement can be produced with the set.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a plug connector with a solder anchor according to an example in a perspective side view;

FIG. 2 shows an isolated perspective representation of the solder anchor from FIG. 1;

FIG. 3 shows the plug connector from FIG. 1 in a top view; and

FIG. 4 shows the plug connector from FIG. 1 in a sectional side view along the section line shown in FIG. 3.

### DETAILED DESCRIPTION

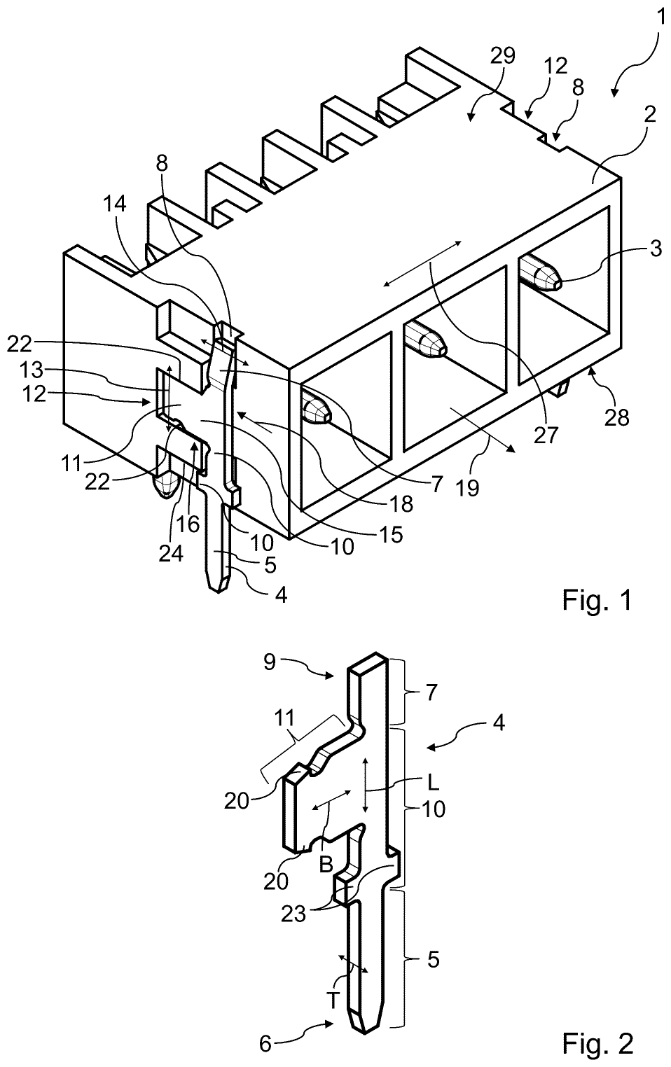

FIGS. 1, 3, and 4 show a plug connector 1 that is intended for connection to a printed circuit board and designed as a contact pin strip, having a solder anchor 4 according to an example, in various views. FIG. 2 shows the solder anchor 4 in an isolated perspective representation in addition. The plug connector 1 and the solder anchor 4 can be provided as a set.

The plug connector 1 has a connector housing 2 and electrical contacts 3—designed as contact pins—for contacting mating contacts of a mating connector and is connectable to the plug connector 1. As can be seen in FIG. 1, for example, the solder anchor 4 is formed separately and is arranged on the connector housing 2. The solder anchor 4 serves to mechanically secure the connection of the plug connector 1 to the printed circuit board.

As is evident from FIGS. 1, 3, and 4, in particular, the solder anchor 4 is designed as an essentially flat, planar component so that a space-saving arrangement of the solder anchor 4 on the connector housing 2 is made possible and a size of the plug connector 1 is not increased appreciably in a pitch direction 27. The planar component can, for example, be produced as a stamped part, in particular be stamped from a semifinished sheet metal product. As can be seen in FIG. 2, the solder anchor 4 as a planar component has a substantially larger extent in a length direction L and in a width direction B than in a depth direction T.

The solder anchor 4 has a pin-shaped soldering section 5 on a first anchor side 6. The soldering section 5 serves to connect the solder anchor 4 to the printed circuit board. In addition, as can be seen in FIG. 1, the solder anchor 4 has, on a second anchor side 9 opposite the first anchor side 6, a bent locking section 7 for interlocking engagement in a locking opening 8 of the connector housing 2 formed by an indentation in the connector housing 2. The first anchor side 6 and the second anchor side 9 are associated with mutually opposing end sections of the solder anchor 4. The first anchor side 6 faces toward a circuit board side 28 of the connector housing 2. The second anchor side 9 faces toward a housing top 29 of the connector housing 2 opposite the circuit board side 28. The locking section 7 is designed as a bent material tab and has a rectangular basic shape. By means of a bending process, the locking section 7 can be transformed from a straight, flat arrangement in a preassembly state and intermediate assembly state into the bent arrangement for engagement in the locking opening 8.

The soldering section 5 and the locking section 7 are connected to one another by a connecting section 10 of the solder anchor 4, as shown in detail in FIG. 2, for example. The connecting section 10 can, as shown, have a greater extent in the length direction L than the locking section 7 and have at least as great an extent in the length direction L as the soldering section 5. An attachment section 11 that is accommodated in an interlocking manner in a solder anchor receptacle 12 of the connector housing 2, for example as shown in FIGS. 1 and 4, projects from the connecting section 10. The attachment section 11 can, as shown in FIG. 2, have a larger dimension in the width direction B than the soldering section 5 and the locking section 7. In addition, the attachment section 11 can have a larger dimension in the length direction L than the locking section 7 and have a smaller dimension in the length direction L than the soldering section 5 or the connecting section 10.

A directional interlock with a first direction of interlock 13 can be produced between the attachment section 11 and the solder anchor receptacle 12 by an overlapping of interlocking contours of the attachment section 11 and the solder anchor receptacle 12. Furthermore, an additional directional interlock with a second direction of interlock 14 can be produced between the locking section 7 and the locking opening 8 by an overlapping of the locking section 7 with adjacent housing edges. It is evident from FIG. 1 that the first direction of interlock 13 between the attachment section 11 and the solder anchor receptacle 12 runs essentially perpendicular to the second direction of interlock 14 between the locking section 7 and the locking opening 8. As a result, an especially secure retention of the solder anchor 4 on the connector housing 2 is ensured.

In addition, it is shown in FIG. 1 that an exposed contact surface 15 is formed on a surface of the solder anchor 4 facing away from the connector housing 2 so that a shield element, for example, can be arranged in such a manner on the connector housing 2 and the solder anchor 4 that a shielding transfer is possible between the contact surface 14 and the shield element.

It is evident from FIGS. 1, 3, and 4 taken together that the solder anchor receptacle 12 of the connector housing 2 has an insertion opening 16 for sliding the solder anchor 4 into the solder anchor receptacle 12 along a housing surface 17 of the connector housing 2 in a predefined insertion direction 18 so that simple attachment of the solder anchor 4 to the connector housing 2 is possible and the two-dimensional character of the solder anchor 4 can be used for a slide-in attachment along the housing surface 17. The insertion direction 18 of the solder anchor 4 in the solder anchor receptacle 12 in this case is in the opposite direction to a mating direction 19 of the plug connector 1 for connection to a mating connector, as can be seen in FIGS. 1 and 4, so that the attachment of the solder anchor 4 to the connector housing 2 is unaffected by a mating process between the plug connector 1 and a mating connector.

As can be seen in FIG. 4, two latching elements 20 for the purpose of latching onto two corresponding mating latching elements 21 of the solder anchor receptacle 12 are arranged on the attachment section 11 of the solder anchor 4 so that a simple and reliable fastening of the solder anchor 4 to the connector housing 2 is made possible. The latching elements 20 can, as depicted, be designed as locking hooks. The region of the attachment section 11 in which the latching elements 20 are arranged can be referred to as a latching section. The solder anchor 4 can be insertable into the solder anchor receptacle 12 with the latching section foremost. The mating latching elements 21 can, as depicted, be designed as latching projections with latching edges that the locking hooks can engage behind.

It is shown in FIG. 1 in addition that the solder anchor receptacle 12 of the connector housing 2 has two parallel housing webs 22 reaching over the solder anchor 4 for guiding the attachment section 11 of the solder anchor 4 in the solder anchor receptacle 12 so that a defined guidance of the solder anchor 4 in the solder anchor receptacle 12 is possible and a slide-in attachment is facilitated. An indication can be seen in FIG. 1 that the housing webs 22 have an angled profile for the purpose of forming a dovetail contour so that an interlocking guide profile is provided.

Furthermore, it is visible in FIGS. 1 and 4, for example, that a support tab 23 that projects from the connecting section 10 for the purpose of supporting the solder anchor 4 on a housing edge 24 of the connector housing 2 is formed on the connecting section 10 of the solder anchor 4 so that an additional bracing of the solder anchor 4 on the connector housing 2 is made possible. According to the example shown, a cross-shaped support region with two opposite support tabs 23 is formed in this case.

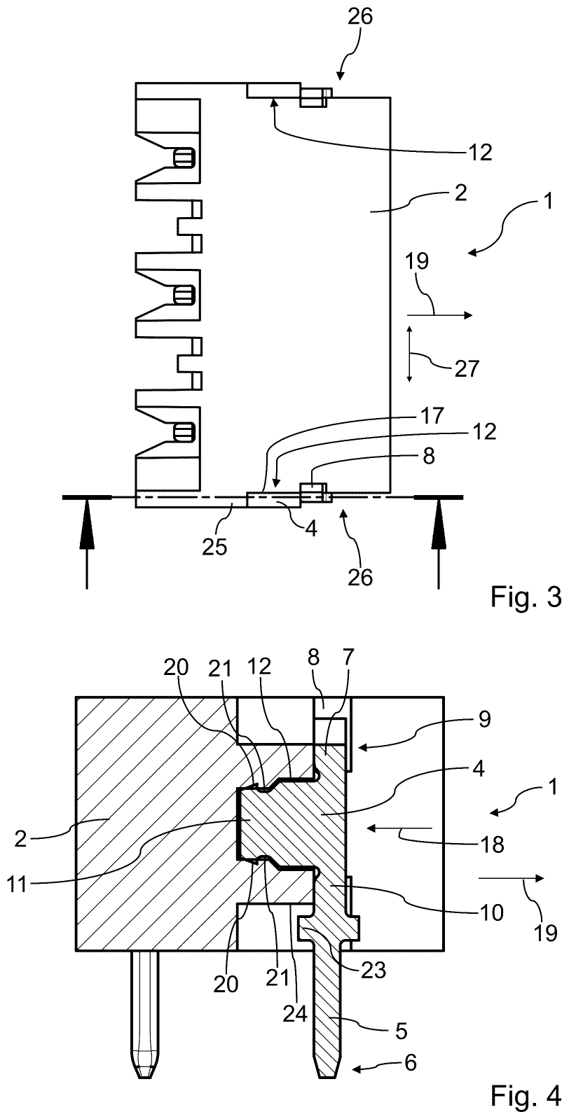

It is evident from FIG. 3 that the solder anchor 4 accommodated in the solder anchor receptacle 12 terminates flush, at least in sections, with the housing wall 25 of the connector housing 2 adjacent to the solder anchor receptacle 12 so that additional accessory elements such as shield elements or locking latches can be arranged on the plug connector 1 in a manner that is simple and unaffected by the solder anchor 4.

In addition, it is shown in FIG. 3 that the connector housing 2 has two solder anchor receptacles 12 that are formed on two mutually opposite outer surfaces 26 of the connector housing 2. The outer surfaces 26 in this case constitute end faces of the connector housing 2. As an identical component, the solder anchor 4 can be placed on a choice of one of the outer surfaces 26 in this case, or two solder anchors 4 can be arranged on both outer surfaces 26. A mounting of the solder anchor 4 on the associated solder anchor receptacle 12 can be accomplished in such a manner that a receiving of the solder anchor 4 takes place through the attachment section 11 in the solder anchor receptacle 12 (intermediate assembly position) in a first installation step. Subsequently, the bending of the locking section 7 into the locking opening 8 takes place.

By means of the plug connector 1 described on the basis of the above example and the solder anchor 4, a reliable securing of a mechanical connection between the plug connector 1 and a printed circuit board can be made possible. The solder anchor 4 can be attached to the plug connector 1 in a simple and secure manner and, on account of the proposed attachment concept of the solder anchor 4 to the plug connector 1, represents a very low-profile and nevertheless mechanically strong connecting component of the plug connector 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A plug connector for connection to a printed circuit board, the plug connector comprising:
a connector housing; and
electrical contacts to contact mating contacts of a mating connector that is connectable to the plug connector; and
a separately formed solder anchor arranged on the connector housing to mechanically secure the connection of the plug connector to the printed circuit board,
wherein the solder anchor is an essentially flat, planar component and has, on a first anchor side, a soldering section for connection to the printed circuit board, and has, on a second anchor side opposite the first anchor side, a bent locking section for interlocking engagement in a locking opening of the connector housing,
wherein the soldering section and the locking section are connected to one another by a connecting section, and
wherein an attachment section, which is accommodated in an interlocking manner in a solder anchor receptacle of the connector housing, projects from the connecting section.

2. The plug connector according to claim 1, wherein a first direction of interlock between the attachment section and the solder anchor receptacle runs essentially perpendicular to a second direction of interlock between the locking section and the locking opening.

3. The plug connector according to claim 1, wherein an exposed contact surface is formed on a surface of the solder anchor facing away from the connector housing.

4. The plug connector according to claim 1, wherein the solder anchor receptacle of the connector housing has an insertion opening for sliding the solder anchor into the solder anchor receptacle along a housing surface of the connector housing in a predefined insertion direction.

5. The plug connector according to claim 4, wherein the insertion direction of the solder anchor in the solder anchor receptacle is in the opposite direction to a mating direction of the plug connector for connection to a mating connector.

6. The plug connector according to claim 1, wherein a latching element that is configured to latch onto a mating latching element of the solder anchor receptacle and/or to dig into the material of the connector housing inside the solder anchor receptacle with a sharp-edged region is arranged on the attachment section of the solder anchor.

7. The plug connector according to claim 1, wherein the solder anchor receptacle of the connector housing has two parallel housing webs reaching over the solder anchor for guiding the attachment section of the solder anchor in the solder anchor receptacle.

8. The plug connector according to claim 1, wherein a support tab that projects from the connecting section for the purpose of supporting the solder anchor on a housing edge of the connector housing is formed on the connecting section of the solder anchor.

9. The plug connector according to claim 1, wherein the solder anchor accommodated in the solder anchor receptacle terminates, at least in sections, flush with the housing wall of the connector housing adjacent to the solder anchor receptacle.

10. The plug connector according to claim 1, wherein the connector housing has two solder anchor receptacles that are formed on two mutually opposite outer surfaces of the connector housing.

11. The plug connector according to claim 1, wherein the solder anchor is produced as a stamped part.

12. The plug connector according to claim 1, wherein the plug connector is a contact pin strip or a socket strip.

13. A set comprising a plug connector and a solder anchor to create the plug connector according to claim 1.
